(19) United States
(12) Patent Application Publication
(10) Pub. No.: US 2024/0394164 A1
(43) Pub. Date: Nov. 28, 2024

(54) MEMORY PERFORMANCE EVALUATION USING ADDRESS MAPPING INFORMATION

(71) Applicant: Micron Technology, Inc., Boise, ID (US)

(72) Inventors: Ziqing WU, Shanghai (CN); Wenjun WU, Shanhai (CN); Xiaolai ZHU, Shanghai (CN); Chunyu SHENG, Shanghai (CN); Xiao WANG, Shanghai (CN)

(21) Appl. No.: 18/696,218

(22) PCT Filed: Jul. 25, 2022
(86) PCT No.: PCT/CN2022/107557

§ 371 Date: Mar. 27, 2024

(51) Int. Cl. G06F 11/30; G06F 11/34

(52) U.S. Cl. CPC G06F 11/3037; G06F 11/3409; G06F 11/3466

(57) ABSTRACT

Methods, systems, and devices for memory performance evaluation using address mapping information are described. A memory system may write a data file associated with a range of logical block addresses to a first set of blocks in a set of memory dies. The memory system may then determine, for a memory die of the set of memory dies that stores a portion of the data file, a quantity of read operations for reading the portion of the data file. The memory system may determine the quantity of read operations based on address mapping information that maps logical block addresses associated with the datafile to physical addresses. After determining the quantity of read operations, the memory device may use the quantity of read operations to determine a performance metric associated with the data file and the first set of blocks.

### CROSS REFERENCE

The present Application for patent is a 371 national phase filing of International Patent Application No. PCT/CN2022/107557 by Wu et al., entitled “MEMORY PERFORMANCE EVALUATION USING ADDRESS MAPPING INFORMATION”, filed Jul. 25, 2022, assigned to the assignee hereof, and expressly incorporated by reference in its entirety herein.

### FIELD OF TECHNOLOGY

The following relates to one or more systems for memory, including memory performance evaluation using address mapping information.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports memory performance evaluation using address mapping information in accordance with examples as disclosed herein.

FIG. 2 illustrates an example of a system that supports memory performance evaluation using address mapping information in accordance with examples as disclosed herein.

FIG. 3 illustrates an example of memory dies that support memory performance evaluation using address mapping information in accordance with examples as disclosed herein.

FIG. 4 illustrates an example of a process flow that supports memory performance evaluation using address mapping information in accordance with examples as disclosed herein.

FIG. 5 shows a block diagram of a memory system that supports memory performance evaluation using address mapping information in accordance with examples as disclosed herein.

FIG. 6 shows a flowchart illustrating a method or methods that support memory performance evaluation using address mapping information in accordance with examples as disclosed herein.

### DETAILED DESCRIPTION

A memory system may include multiple memory dies that may include blocks of memory cells grouped into pages. To increase efficiency and decrease latency, the memory system may be configured to perform parallel access operations in which pages from different blocks (and potentially different memory dies) are accessed concurrently (e.g., at partially overlapping times or wholly overlapping times). For example, a memory system may perform parallel access operations on data that is written to continuous physical pages (e.g., physical pages with sequentially indexed physical addresses) in the same page line on a die. But over time a file stored in the memory system may become spread out (e.g., be distributed) among the various pages, page lines, and memory dies in the memory system, a phenomenon referred to as fragmentation. Fragmented data files may reduce parallelism (e.g., the ability of the memory system to perform parallel access operations), which in turn may decrease the performance of the memory system, among other disadvantages.

According to the techniques described herein, a memory system may use address mapping information to determine whether the fragmentation of data file has decreased performance enough to justify a corrective action, such as a maintenance operation (e.g., a defragmentation operation). For example, the memory system may use an address mapping table to determine the respective fragment level (which may in some examples be indicated by a predicted quantity of access operations) for each memory die that stores a subset of a data file. The memory system may determine a fragment level. For example, the memory system may determine a normalized fragment level by dividing the worst fragment level by a threshold fragment level associated with the data file. Using fragment level-to-performance level mapping information (e.g., from a performance mapping table), the memory system may determine a performance level associated with the normalized fragment level. If the performance level satisfies a threshold (e.g., is below the threshold), the memory device may perform a maintenance operation (e.g., defragmentation operation) on the data file to counteract or avoid the problems associated with fragmented information (e.g., reduced parallelism, decreased performance of the memory system).

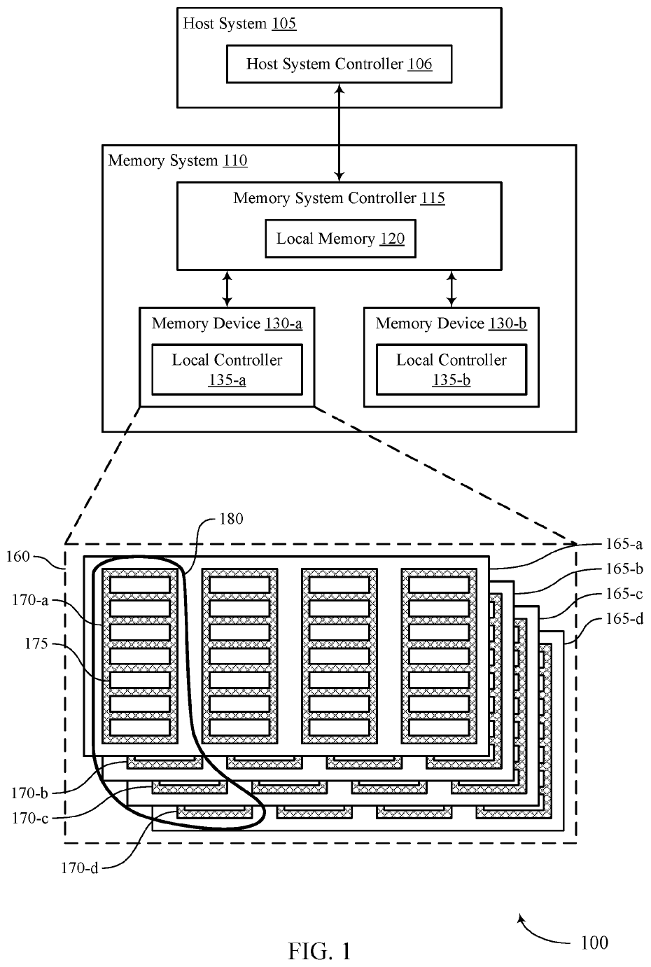

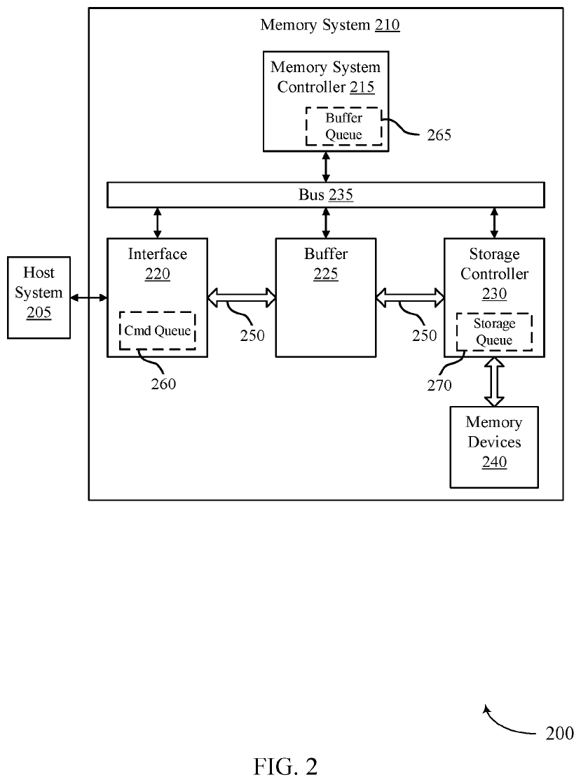

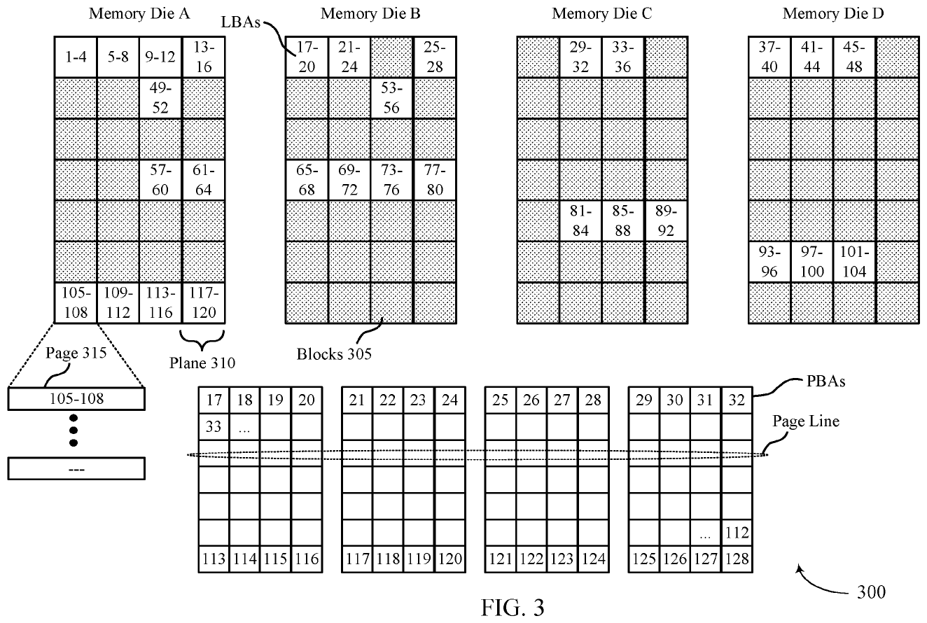

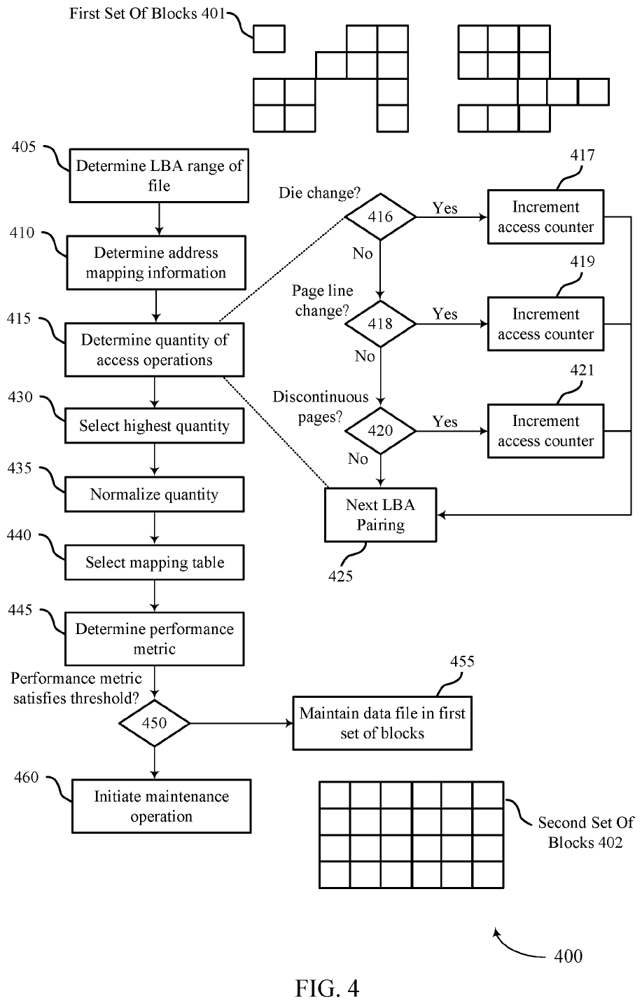

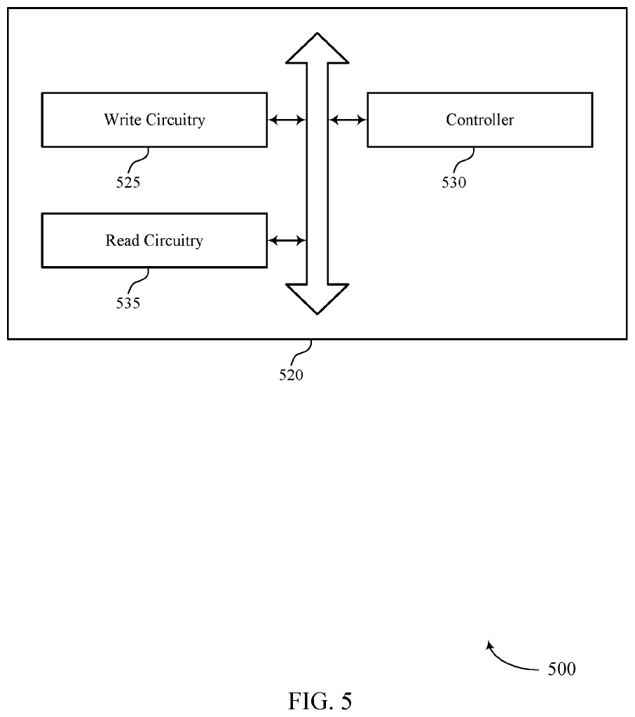

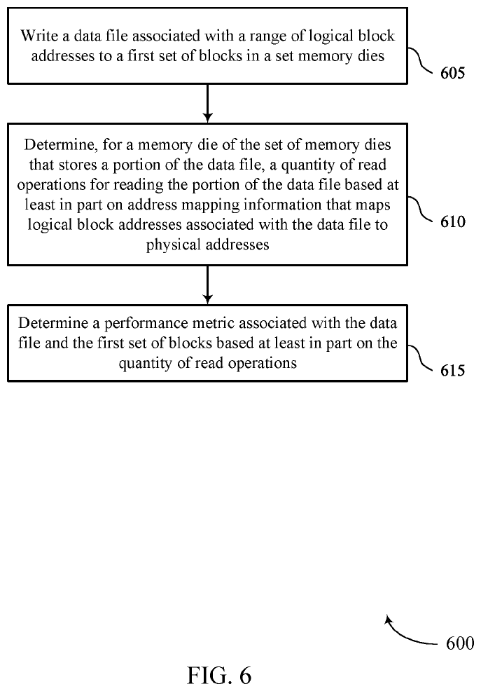

Features of the disclosure are initially described in the context of systems, devices, and circuits with reference to FIGS. 1 through 2. Features of the disclosure are described in the context of memory dies and a process flow with reference to FIGS. 3 through 4. These and other features of the disclosure are further illustrated by and described in the context of an apparatus diagram and flowchart that relate to memory performance evaluation using address mapping information with reference to FIGS. 5 through 6.

FIG. 1 illustrates an example of a system 100 that supports memory performance evaluation using address mapping information in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical page addresses (PPAs)) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The memory system 110 may support parallel access operations across the blocks 170. For example, the memory system 110 may access (e.g., read) one or more pages per block in a set of blocks (e.g., in a virtual block) in parallel (e.g., concurrently). Within a memory die, the memory system 110 may perform parallel access operations on data that are written to pages, such as continuous pages in a die (e.g., if the pages storing the data are in the same page line), where continuous pages refer to pages with sequentially indexed physical page addresses (PPAs). It should be appreciated that some continuous pages may be associated with continuous blocks (e.g., blocks with sequentially indexed physical block addresses (PBAs)), and that discontinuous blocks may be associated with discontinuous pages.

But over time (e.g., due to maintenance operations such as garbage collection), the data in a data file may be distributed to non-continuous pages (e.g., pages and blocks with non-sequentially indexed physical addresses), different page lines, and different dies. The distribution of a data file across page lines, non-continuous pages, and different memory dies may be referred to as fragmentation, and higher fragmentation levels may be associated with higher quantities of read operations.

As a data file becomes more fragmented, the parallelism or other access efficiencies of the memory system 110 may suffer. To improve access performance, the memory system 110 may implement a maintenance operation such as a defragmentation operation that writes a fragmented data file to continuous blocks. Because maintenance operations consume time and power, other memory systems may verify that the fragment level of a data file is sufficiently severe before initiating a maintenance operation for that data file (e.g., to avoid unnecessary maintenance operations). To determine the fragment level, the other memory systems may read the entire data file. But reading an entire data file to determine the fragment level for the data file may consume excess power and time.

According to the techniques described herein, the memory system 110 may use address mapping information, such as an address mapping table (e.g., an L2P table), to determine whether a given data file is fragmented enough to warrant a maintenance operation, thereby avoiding reading the entire data file. For example, the memory system 110 may use the address mapping table to determine a fragment level for the data file, which in turn may be used to determine a performance level associated with the data file. The memory system 110 may then determine whether to perform a maintenance operation on the data file based on (e.g., as a function of) or in response to the performance level. Thus, the memory system 110 may use address mapping information to determine performance information that the memory system 110 uses to manage maintenance operations.

The system 100 may include any quantity of non-transitory computer readable media that support memory performance evaluation using address mapping information. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

FIG. 2 illustrates an example of a system 200 that supports memory performance evaluation using address mapping information in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 240 to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) if the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

Once the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., PPAs, PBAs) associated with memory cells within the memory devices 240. For example, the host system 205 may issue commands indicating one or more LBAs and the memory system controller 215 may identify one or more physical addresses (e.g., PPAs, PBAs) indicated by the LBAs. In some cases, one or more contiguous LBAs may correspond to noncontiguous physical addresses (e.g., PPAs, PBAs). In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

In some examples, the memory system 210 may write a data file to the memory device(s) 240. For instance, the memory system 210 may write the data file to continuous pages within the memory device(s) in order to increase parallelism during an access operation (e.g., a read operation). Over time (e.g., due to maintenance operations such as garbage collection), the data file may become distributed across non-continuous pages and/or different page lines, where a page line refers to a set of pages with the same page line number in their respective block. According to the techniques described herein, the memory system 210 may determine whether to perform a maintenance operation on the data file by referencing address mapping information (e.g., contained in an address mapping table) that indicates mappings between LBAs associated with the data file and physical addresses (e.g., PPAs) associated with memory media that store the data file. By using address mapping information as the basis for performing a maintenance operation, the memory system 210 may avoid reading the data file, which may be a time-consuming and power-consuming process.

FIG. 3 illustrates an example of memory dies 300 that support memory performance evaluation using address mapping information in accordance with examples as disclosed herein. The memory dies 300 may be examples of memory dies as described herein and may include, for example, memory die A, memory die B, memory die C, and memory die D. Although described with reference to four memory dies, other quantities of memory dies are contemplated and within the scope of the present disclosure. A memory system that has a data file written to the memory dies 300 may use address mapping information (e.g., from an address mapping table) to determine a performance metric associated with the data file, which in turn may be used to determine whether to perform a maintenance operation on the data file.

The memory dies 300 may include planes 310 of blocks 305, each of which may include one or more pages 315 of memory cells. A page may have the capacity to store one or more virtual pages, where a virtual page refers to the page-sized data set (e.g., 4 kB) associated with an LBA. In some examples, the size of a page may be 16 kB and the size of a virtual page may be 4 kB. In such examples, each page may have the capacity to store four virtual pages, each of which may be associated with a respective LBA. For example, one of the pages 315 (which may have an associated PPA) in the block 113 may store four virtual pages associated with LBAs 105-108.

An L2P mapping table may map the LBAs for virtual pages to the corresponding PPAs for the physical pages that store the virtual page data. In some examples (e.g., if a physical page is 4× as large as a virtual page), four sequential LBAs may be mapped to one PPA. A set of pages with the same page number in their respective block may be referred to herein as a page line.

Each block may have an associated PBA. The PBAs of the blocks 305 may be sequentially indexed starting from the upper left block in the first row of memory die A and proceeding across the memory dies until the last block in the first row of memory die D, then wrapping around to the first block in the second row of memory die A. The lower figure in FIG. 3 shows a representative set of the sequentially indexed PBAs for the blocks 305 (starting with PBA 17 and ending with PBA 128).

The virtual pages of the data file written to the memory dies 300 may be grouped into subsets of data, that are written to a page. For instance, the first subset of data in the data file may be associated with LBAs 1-4 and may be written to a page in the block assigned PBA 17. The second subset of data in the data file may be associated with LBAs 5-8 and may be written to a page in the block assigned PBA 18. And so on and so forth. In the given example, the data file is associated with 120 LBAs (LBA 1 through LBA 120), the collection of which may be referred to as a range of LBAs, a set of LBAs, or other suitable terminology. However, other quantities LBAs are contemplated and within the scope of the present disclosure. Each memory die 300 may store a portion of the data file, where a portion refers to one or more subsets of the data file. For example, the portion of the data file stored in memory die A may include the subsets of data associated with LBAs 1-16, 49-52, 57-64, and 105-120.

The address mapping information in one or more address mapping tables (e.g., L2P table(s)) may map the logical addresses (e.g., LBAs) associated with the data file to physical addresses (e.g., PBAs and/or PPAs) of the memory dies 300. For example, the address mapping information in an address mapping table may map LBAs 1-4 to a PPA in PBA 17 (indicating the subset of data associated with LBAs 1-4 is written to a page in the block associated with PBA 17), may map LBAs 5-8 to a PPA in PBA 18, and so on and so forth as illustrated. Thus, sequentially indexed LBAs may be mapped to non-sequentially indexed PPAs (e.g., discontinuous physical pages) and or non-sequentially indexed PBAs (e.g., discontinuous physical blocks). So, the data file may be fragmented at least because the data file is written to non-sequentially indexed physical addresses (e.g., non-continuous pages, non-continuous blocks 305). In some examples, the address mapping information may indicate the PPA, page line, PBA, memory die, or any combination thereof, for subsets of the data file.

As noted, the distribution of a data file across discontinuous physical memory media (e.g., pages, blocks) may reduce the parallelism of the memory system by increasing the quantity of access operations (e.g., read operations) used to read the data file. Additionally, other properties of the data file may also reduce the parallelism of the memory system by increasing the quantity of access operations used to read the data file. For example, changing memory dies to read the data file may increase the quantity of access operations. So, sequentially indexed LBAs that span two memory dies may be associated with an increase of access operations. As another example, changing page lines to read the data file may increase the quantity of access operation, where a page line refers to a set of physical pages with the same page number. So, sequentially indexed LBAs that span two page lines may be associated with an increase in access operations.

To determine whether a data file is fragmented severely enough to warrant a maintenance operation, the memory system may reference address mapping information associated with the logical addresses (e.g., LBAs) for the data file. For example, the memory system may reference the mapping table(s) that contain the address mapping information to determine the fragment level for each memory die. The fragment level of a memory die may be based on (e.g., proportional to) or in response to the quantity of access operations for reading the portion of the data file written to that memory die.

To determine the quantity of access operations for a memory die, the memory system may consider the following metrics associated with the memory die: changes in memory dies, changes in page lines, and quantities of non-sequentially indexed physical addresses (e.g., PPAs). In the given example, the quantity of access operations for memory die A may be four, the quantity of access operations for memory die B may be four, the quantity of access operations for memory die C may be two, and the quantity of access operations for memory die D may be two.

For memory die A, the memory system may compare LBA 16 with LBA 17 and determine that there is a die change (because LBA 16 is mapped to a PPA on memory die A and LBA 17 is mapped to a PPA on memory die B). Based on the die change, the memory system may increment the access counter for memory die A by one (e.g., from zero to one). The memory system may compare LBA 52 with LBA 53 and determine that i) the corresponding PPAs are non-continuous (because there are interceding PBAs) and ii) there is a die change (because LBA 52 is mapped to a PPA on memory die A and LBA 53 is mapped to a PPA on memory die B). Accordingly, the memory system may increment the access counter for memory die A by one (e.g., from one to two). The memory system may compare LBA 64 with LBA 65, determine that there is a die change, and increment the access counter for memory die A by one (e.g., from two to three). To compensate for accessing LBAs 105-120 (the last LBAs in the data file), the memory system may increment the access counter for memory die A by one (e.g., from three to four).

For memory die B, the memory system may compare LBA 24 with LBA 25 and determine that i) the corresponding PPAs are non-continuous (because there are interceding PBAs). Accordingly, the memory system may increment the access counter for memory die B by one (e.g., from zero to one). The memory system may compare LBA 28 with LBA 29 and determine that i) the corresponding PPAs are non-continuous (because there are interceding PBAs) and ii) there is a die change (because LBA 28 is mapped to a PPA on memory die B and LBA 29 is mapped to a PPA on memory die C). Accordingly, the memory system may increment the access counter for memory die B by one (e.g., from one to two). The memory system may compare LBA 56 with LBA 57 and determine that i) the corresponding PPAs are non-continuous, ii) there is a die change, and iii) there is a page line change (because LBA 56 is on a different page line than LBA 57 by virtual of being in a different row of physical blocks). Accordingly, the memory system may increment the access counter for memory die B by one (e.g., from two to three). The memory system may compare LBA 80 with LBA 81 and determine that i) the corresponding PPAs are non-continuous, ii) there is a die change, and iii) there is a page line change. Accordingly, the memory system may increment the access counter for memory die B by one (e.g., from three to four).

For memory die C, the memory system may compare LBA 36 with LBA 37 and determine that i) the corresponding PPAs are non-continuous and ii) there is a die change. Accordingly, the memory system may increment the access counter for memory die C by one (e.g., from zero to one). The memory system may compare LBA 92 with LBA 93 and determine that i) there is a die change, and ii) there is a page line change. Accordingly, the memory system may increment the access counter for memory die C by one (e.g., from two to three).

For memory die D, the memory system may compare LBA 48 with LBA 49 and determine that determine that i) the corresponding PPAs are non-continuous, ii) there is a die change, and iii) there is a page line change. Accordingly, the memory system may increment the access counter for memory die D by one (e.g., from zero to one). The memory system may compare LBA 104 with LBA 105 and determine that determine that i) the corresponding PPAs are non-continuous, ii) there is a die change, and iii) there is a page line change. Accordingly, the memory system may increment the access counter for memory die D by one (e.g., from one to two).

Upon determining the quantity of access operations (e.g., the fragment level) for the memory dies 300, the memory system may select the memory die with the highest quantity of access operations (e.g., the most severe fragmentation) as the representative memory die for the memory dies 300. The memory system may then normalize the quantity of access operations for the memory dies 300 by dividing the highest quantity of access operations (which may also be referred to as the real parallelism) by a threshold quantity (which may also be referred to as the ideal parallelism) given by a normalization factor. For example, the memory system may determine the normalized quantity of access operations by dividing the highest quantity of access operations by the normalization factor, which may be equal to the quantity of logical block addresses (denoted the LBA count) associated with the data file divided by the quantity of virtual pages per page line of the memory dies 300. A virtual page may refer to the page-sized data set (e.g., 4 kB) associated with a logical address. In some examples, the normalization factor may represent the hypothetical quantity of access operations for reading the data file if the data file were exclusively written to continuous physical blocks.

Normalizing the quantity of access operations may allow the memory system to account for differently sized data files. For example, without normalization, a large data file may appear severely fragmented (because it is associated with a high quantity of access operations due to its size) even though the data file is negligibly fragmented. And a small data file may appear negligibly fragmented (because it is associated with a low quantity of access operations due to its size) even though the data file is severely fragmented. So, to account for differently sized data files, the memory system may normalize the quantity of access operations associated with the data file by dividing the actual quantity of access operations for accessing the data file by, e.g., the minimum quantity of access operations possible for accessing the data file (as given by the normalization factor for that data file). Framed another way, the memory system may determine how the actual quantity of access operations compares to the minimum quantity of access operations.

After determining the normalized quantity of access operations, the memory system may determine a performance level drop associated with the normalized quantity of access operations. To do so, the memory system may reference performance mapping information that maps quantities of access operations (e.g., normalized quantities of access operations) to reductions in performance level relative to an unfragmented data file. For example, the performance mapping information may map x access operations to a 5% reduction in performance (e.g., a 5% increase in latency), may map y access operations to a 10% reduction in performance (e.g., a 10% increase in latency), and so on and so forth. The performance mapping information may be included in one or more predetermined tables, plots, or other data structures.

In some examples, the memory system may directly use the reduction in performance as the basis for initiating a maintenance operation (e.g., a defragmentation operation). For example, the memory system may initiate a maintenance operation for a data file if the data file is associated with a threshold reduction in performance. In other example, the memory system may indirectly use the reduction in performance as the basis for initiating a maintenance operation. For example, the memory system may determine the overall performance level associated with the data file based on (e.g., using) or in response to the reduction in performance and may initiate a maintenance operation for the data file if the data file is associated with a threshold performance level. If a defragmentation operation is initiated, the defragmentation operation may include writing the data file to a set of continuous blocks.

The relationship between quantities of access operations and performance level reduction may vary with data file size, where the size of a data file may refer to the quantity of LBAs associated with the data file or the quantity of bits in the data file. To account for differently sized data files, the memory system may include multiple performance mapping tables with mappings (between the quantities of access operations and performance level drops) that are based on (e.g., a function of) or in response to the size of the data file. For example, the memory system may include a first performance mapping table for small data files (e.g., data files with less than a 32 MB) and may include a second performance mapping table for large data files (e.g., data files with more than 32 MB). In such a scenario, the memory system may select a performance mapping table for use based on or in response to the size of the data file implicated in the maintenance analysis.

Thus, a memory system may use address mapping information to evaluate performance and manage maintenance operations.

FIG. 4 illustrates an example of a process flow 400 that supports memory performance evaluation using address mapping information in accordance with examples as disclosed herein. Aspects of the process flow 400 may be implemented by a system such as a memory system or a memory device as described herein. The system may include a set of memory dies that store a data file written to blocks in the set of memory dies. For example, the data file may be written to a first set of blocks 401 that includes discontinuous pages. By implementing aspects of the process flow 400, the system may determine performance metrics for data files and manage maintenance operations using address mapping information, which may be more efficient relative to other techniques.

Aspects of the process flow 400 may be implemented by a controller, among other components. Additionally or alternatively, aspects of the process flow 400 may be implemented as instructions stored in memory (e.g., firmware stored in a memory coupled with a memory system 110). For example, the instructions, if executed by a controller (e.g., the memory system controller 115), may cause the controller to perform the operations of the process flow 400.

At 405, the range of logical addresses (e.g., LBAs) associated with the data file may be determined (e.g., by the system). In some examples, the system may also determine the size of the range of LBAs associated with the data file (e.g., so that the system can select an appropriate performance mapping table at 440).

At 410, the address information for the range of LBAs may be determined (e.g., by the system). For example, the system may read one or more address mapping tables from memory. At 425, quantities of access operations (e.g., read operations) for reading the data file may be determined (e.g., by the system). For example, for each memory die that stores a portion of the data file the system may determine the quantity of access operations for reading the portion of the data file stored in that memory die. To do so, system may implement the operations at 416 through 425 for some or all of the memory dies in the set of memory die.

At 416, it may be determined whether a there is a die change associated with the memory die. For example, for a given LBA associated with the portion of the data file stored in the memory die, the system may determine whether a sequentially indexed LBA (also associated with the data file) is mapped to a PPA for a page of a block on a different memory die. Put another way, the system may determine whether the PPAs mapped to two sequentially indexed LBAs (each associated with the data file) are associated with different memory dies. For example, given a first subset of the data file associated with LBA=n and a second subset of the data file associated with LBA=n+1, the system may determine whether the PPA mapped to LBA=n+1 is associated with the same memory die as the PPA mapped to LBA=n. The system may make the determination at 416 based on (e.g., using) or in response to the address mapping information determined at 410.

If, at 416, it is determined that there is a die change, the process may proceed to 417 and an access counter for the memory die may be incremented (e.g., by the system). The access counter may indicate the quantity of access operations associated with reading the portion of the data file from the memory device. If no die change is determined at 416, the process may proceed to 418.

At 418, it may be determined whether there is a page line change associated with the memory die. For example, for a given LBA associated with the portion of the data file stored in the memory die, the system may determine whether a sequentially indexed LBA (also associated with the data file) is associated with a different page line. To illustrate, given a first subset of the data file associated with LBA=n and a second subset of the data file associated with LBA=n+1, the system may determine whether the page line associated with the first subset is the same as the page line associated with the second subset.

If, at 418, it is determined that there is a page line change, the process may proceed to 419 and the access counter for the memory die may be incremented (e.g., by the system). If no die change is determined at 418, the process may proceed to 420. The system may make the determination at 418 based on (e.g., using) or in response to the address mapping information determined at 410.

At 420, it may be determined whether discontinuous pages are associated with the memory die. For example, for a given LBA associated with the portion of the data file stored in the memory die, the system may determine whether a sequentially indexed LBA (also associated with the data file) is associated with a discontinuous page. Put another way, the system may determine whether two sequentially indexed LBAs are mapped to non-sequentially indexed PPAs. To illustrate, given a first subset of the data file associated with LBA=n and a second subset of the data file associated with LBA=n+1, the system may determine whether the PPA mapped to LBA=n+1 is sequentially indexed relative to the PPA mapped to LBA=n.

If, at 420, it is determined that there are discontinuous pages, the process may proceed to 421 and the access counter for the memory die may be incremented (e.g., by the system). If no discontinuous pages are determined at 420, the process may proceed to 425 and the memory system may analyze another set of LBAs associated with the data file. The system may make the determination at 420 based on (e.g., using) or in response to the address mapping information determined at 410.

The operations at 416 through 425 may be repeated until the LBAs associated with the memory dies (and data file) have been evaluated.

The quantity of access operations determined for a memory die at 415 may be equal to the access counter for that memory die. After determining the quantity of access operations for the memory dies, one of the quantities (e.g., the highest quantity) may be selected at 430 as the representative quantity for defragmentation management. For example, if memory die A has 20 access operations, memory die has 25 access operations, and memory die C has 30 access operations, the system may select 30 access operations as the representative quantity for defragmentation management. In some examples, the highest quantity of access operations may be selected as the representative quantity because the performance of the system may be linked to (e.g., determined by) the memory die with the most fragmentation.

At 435, the representative quantity of access operations may be normalized (e.g., by the system). For example, the system may divide the representative quantity of access operations by a threshold quantity of access operations. In some examples, the threshold quantity of access operations may be given by (e.g., equal to) the normalization factor for the data file, which may be the quotient of the quantity of logical block addresses in the range of LBAs divided by the quantity of virtual pages per page line.

At 440, a performance mapping table may be selected (e.g., by the system). For example, the system may select between a first performance mapping table associated with a first range of data file sizes (e.g., 0 MB-32 MB) and a second performance mapping table associated with a second range of datafile sizes (e.g., 32+MB). Each performance table may map quantities of access operations (e.g., normalized quantities) to a corresponding performance metric. In some examples, the system may select for use the performance mapping table with the range of data file sizes that includes the size of the data file stored in the memory dies.

An example performance mapping table is illustrated in Table 1. In Table 1, quantities of access operations are mapped to A) performance reduction percentages and B) overall performance levels relative to max performance levels.

TABLE 1

| | Performance Metric | Performance Metric |
|---|---|---|
| Quantity of Access | (Performance | (Performance Relative to |
| Operations | Drop) | Max Performance) |
| 0 | 0% | 100% |
| 5 | 17% | 83% |
| 10 | 29% | 71% |
| 15 | 34% | 66% |
| . . . | . . . | |

At 445, a performance metric associated with the normalized quantity of access operations may be determined (e.g., by the system). The system may determine the performance metric based on (e.g., using) or in response to the performance mapping information in the performance mapping table selected at 440. For example, the system may use the performance mapping table to determine that the performance metric corresponds to normalized quantity of access operations. The performance metric may represent an increase in latency relative to a threshold latency for reading the data file or the performance metric may represent an overall latency for reading the data file. It should be appreciated that a reduction in performance may be associated with an increase in latency (e.g., a 17% reduction in performance may be represented by a 17% increase in latency).

At 450, it may be determined whether the performance metric satisfies a threshold. For example, if the performance metric represents an increase in latency, the system may determine whether the increase in latency satisfies (e.g., is greater than) a threshold. If, at 450, it is determined that the performance metric does not satisfy the threshold, the process may proceed to 455. At 455, the data file may be maintained in the first set of blocks 401. If, at 450, it is determined that the performance metric satisfies the threshold, the process may proceed to 460. At 460, a maintenance operation (e.g., a defragmentation operation) may be initiated (e.g., by the system). As part of the defragmentation operation, the system may write the data file to a second set of blocks 402 that has more continuous pages than the first set of blocks 401. Thus, the data file may be at least partially defragmented, which may improve the parallelism of the system. The second set of blocks 402 may include some or none of the first set of blocks 401.

Thus, the system may determine performance metrics for data files and manage maintenance operations using address mapping information, which may be more efficient relative to other techniques.

FIG. 5 shows a block diagram 500 of a memory system 520 that supports memory performance evaluation using address mapping information in accordance with examples as disclosed herein. The memory system 520 may be an example of aspects of a memory system as described with reference to FIGS. 1 through 4. The memory system 520, or various components thereof, may be an example of means for performing various aspects of memory performance evaluation using address mapping information as described herein. For example, the memory system 520 may include a write circuitry 525, a controller 530, a read circuitry 535, or any combination thereof. Each of these components may communicate, directly or indirectly, with one another (e.g., via one or more buses).

The write circuitry 525 may be configured as or otherwise support a means for writing a data file associated with a range of logical block addresses to a first set of blocks in a set of memory dies. The controller 530 may be configured as or otherwise support a means for determining, for a memory die of the set of memory dies that stores a portion of the data file, a quantity of read operations for reading the portion of the data file based at least in part on address mapping information that maps logical block addresses associated with the data file to physical addresses (e.g., PPAs). In some examples, the controller 530 may be configured as or otherwise support a means for determining a performance metric associated with the data file and the first set of blocks based at least in part on the quantity of read operations.

In some examples, the write circuitry 525 may be configured as or otherwise support a means for writing the data file to a second set of blocks in the set of memory dies based at least in part on a performance metric.

In some examples, the controller 530 may be configured as or otherwise support a means for determining that the performance metric satisfies a threshold, where the data file is written to the second set of blocks based at least in part on the performance metric satisfying the threshold.

In some examples, the controller 530 may be configured as or otherwise support a means for determining, based at least in part on performance mapping information, that the performance metric corresponds to the quantity of read operations, where the performance metric is determined based at least in part on the performance metric corresponding to the quantity of read operations.

In some examples, the performance mapping information is included in a performance mapping table, and the controller 530 may be configured as or otherwise support a means for selecting the performance mapping table from a plurality of performance mapping tables based at least in part on a size of the range of logical block addresses.

In some examples, the controller 530 may be configured as or otherwise support a means for determining, based at least in part on the address mapping information, that a second logical block address associated with the data file and sequential to a first logical block address associated with the portion of the data file is mapped to a second memory die, where the quantity of read operations is determined based at least in part on the second logical block address being mapped to the second memory die.

In some examples, the portion of the data file includes a first subset and a second subset, and the controller 530 may be configured as or otherwise support a means for determining, based at least in part on the address mapping information, that a second logical block address associated with the data file and sequential to a first logical block address associated with the portion of the data file is mapped to a different page line than the first logical block address, wherein the quantity of read operations is determined based at least in part on the second logical block address being mapped to the different page line.

In some examples, the controller 530 may be configured as or otherwise support a means for determining, based at least in part on the address mapping information, that a first logical block address associated with a first subset of the portion of the data file is mapped to a first physical address (e.g., PPA). In some examples, the controller 530 may be configured as or otherwise support a means for determining, based at least in part on the address mapping information, that a second logical block address associated with the data file and sequential to the first logical block address is mapped to a second physical address (e.g., PPA) that is non-sequentially indexed relative to the first physical address, wherein the quantity of read operations is determined based at least in part on the second physical address being non-sequentially indexed relative to the first physical address.

In some examples, the controller 530 may be configured as or otherwise support a means for determining a threshold quantity of access operations associated with the data file, where the performance metric is determined based at least in part on the threshold quantity of access operations.

In some examples, the controller 530 may be configured as or otherwise support a means for dividing the quantity of read operations by the threshold quantity of access operations, where the performance metric is determined based at least in part on dividing the quantity of read operations by the threshold quantity of access operations.

In some examples, the range of logical block addresses includes a quantity of logical block addresses. In some examples, the threshold quantity of access operations is based at least in part on the quantity of logical block addresses in the range of logical block addresses divided by a quantity of virtual pages per page line of the set of memory dies.

In some examples, the read circuitry 535 may be configured as or otherwise support a means for reading an address mapping table from memory after writing the data file to the set of memory dies, where the address mapping information is included in the address mapping table.

In some examples, the performance metric indicates an increase in latency for reading the data file relative to a threshold latency for reading the data file. In some examples, the performance metric indicates a latency for reading the data file written to the first set of blocks.

FIG. 6 shows a flowchart illustrating a method 600 that supports memory performance evaluation using address mapping information in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include writing a data file associated with a range of logical block addresses to a first set of blocks in a set of memory dies. The operations of 605 may be performed in accordance with examples as disclosed herein. In some examples, aspects of the operations of 605 may be performed by a write circuitry 525 as described with reference to FIG. 5.

At 610, the method may include determining, for a memory die of the set of memory dies that stores a portion of the data file, a quantity of read operations for reading the portion of the data file based at least in part on address mapping information that maps logical block addresses associated with the data file to physical addresses. The operations of 610 may be performed in accordance with examples as disclosed herein. In some examples, aspects of the operations of 610 may be performed by a controller 530 as described with reference to FIG. 5.

At 615, the method may include determining a performance metric associated with the data file and the first set of blocks based at least in part on the quantity of read operations. The operations of 615 may be performed in accordance with examples as disclosed herein. In some examples, aspects of the operations of 615 may be performed by a controller 530 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for writing a data file associated with a range of logical block addresses to a first set of blocks in a set of memory dies; determining, for a memory die of the set of memory dies that stores a portion of the data file, a quantity of read operations for reading the portion of the data file based at least in part on address mapping information that maps logical block addresses associated with the data file to physical addresses; and determining a performance metric associated with the data file and the first set of blocks based at least in part on the quantity of read operations.

Aspect 2: The method, apparatus, or non-transitory computer-readable medium of aspect 1, further including operations, features, circuitry, logic, means, or instructions, or any combination thereof for writing the data file to a second set of blocks in the set of memory dies based at least in part on a performance metric.

Aspect 3: The method, apparatus, or non-transitory computer-readable medium of aspect 2, further including operations, features, circuitry, logic, means, or instructions, or any combination thereof for determining that the performance metric satisfies a threshold, where the data file is written to the second set of blocks based at least in part on the performance metric satisfying the threshold.

Aspect 4: The method, apparatus, or non-transitory computer-readable medium of any of aspects 1 through 3, further including operations, features, circuitry, logic, means, or instructions, or any combination thereof for determining, based at least in part on performance mapping information, that the performance metric corresponds to the quantity of read operations, where the performance metric is determined based at least in part on the performance metric corresponding to the quantity of read operations.

Aspect 5: The method, apparatus, or non-transitory computer-readable medium of aspect 4, where the performance mapping information is included in a performance mapping table and the method, apparatuses, and non-transitory computer-readable medium further includes operations, features, circuitry, logic, means, or instructions, or any combination thereof for selecting the performance mapping table from a plurality of performance mapping tables based at least in part on a size of the range of logical block addresses.

Aspect 6: The method, apparatus, or non-transitory computer-readable medium of any of aspects 1 through 5, further including operations, features, circuitry, logic, means, or instructions, or any combination thereof for determining, based at least in part on the address mapping information, that a second logical block address associated with the data file and sequential to a first logical block address associated with the portion of the data file is mapped to a second memory die, wherein the quantity of read operations is determined based at least in part on the second logical block address being mapped to the second memory die.

Aspect 7: The method, apparatus, or non-transitory computer-readable medium of any of aspects 1 through 6, further including operations, features, circuitry, logic, means, or instructions, or any combination thereof for determining, based at least in part on the address mapping information, that a second logical block address associated with the data file and sequential to a first logical block address associated with the portion of the data file is mapped to a different page line than the first logical block address, wherein the quantity of read operations is determined based at least in part on the second logical block address being mapped to the different page line.

Aspect 8: The method, apparatus, or non-transitory computer-readable medium of any of aspects 1 through 7, further including operations, features, circuitry, logic, means, or instructions, or any combination thereof for determining, based at least in part on the address mapping information, that a first logical block address associated with a first subset of the portion of the data file is mapped to a first physical address and determining, based at least in part on the address mapping information, that a second logical block address associated with the data file and sequential to the first logical block address is mapped to a second physical address that is non-sequentially indexed relative to the first physical address, wherein the quantity of read operations is determined based at least in part on the second physical address being non-sequentially indexed relative to the first physical address.

Aspect 9: The method, apparatus, or non-transitory computer-readable medium of any of aspects 1 through 8, further including operations, features, circuitry, logic, means, or instructions, or any combination thereof for determining a threshold quantity of access operations associated with the data file, where the performance metric is determined based at least in part on the threshold quantity of access operations.

Aspect 10: The method, apparatus, or non-transitory computer-readable medium of aspect 9, further including operations, features, circuitry, logic, means, or instructions, or any combination thereof for dividing the quantity of read operations by the threshold quantity of access operations, where the performance metric is determined based at least in part on dividing the quantity of read operations by the threshold quantity of access operations.

Aspect 11: The method, apparatus, or non-transitory computer-readable medium of aspect 10, where the range of logical block addresses includes a quantity of logical block addresses and the threshold quantity of access operations is based at least in part on the quantity of logical block addresses in the range of logical block addresses divided by a quantity of virtual pages per page line of the set of memory dies.

Aspect 12: The method, apparatus, or non-transitory computer-readable medium of any of aspects 1 through 11, further including operations, features, circuitry, logic, means, or instructions, or any combination thereof for reading an address mapping table from memory after writing the data file to the set of memory dies, where the address mapping information is included in the address mapping table.

Aspect 13: The method, apparatus, or non-transitory computer-readable medium of any of aspects 1 through 12, where the performance metric indicates an increase in latency for reading the data file relative to a threshold latency for reading the data file.

Aspect 14: The method, apparatus, or non-transitory computer-readable medium of any of aspects 1 through 13, where the performance metric indicates a latency for reading the data file written to the first set of blocks.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a set of memory dies; and
a controller coupled with the set of memory dies and configured to cause the apparatus to:
write a data file associated with a range of logical block addresses to a first set of blocks in the set of memory dies;
determine, for a memory die of the set of memory dies that stores a portion of the data file, a quantity of read operations for reading the portion of the data file based at least in part on address mapping information that maps logical block addresses associated with the data file to physical addresses; and
determine a performance metric associated with the data file and the first set of blocks based at least in part on the quantity of read operations.

2. The apparatus of claim 1, wherein the controller is further configured to cause the apparatus to:
write the data file to a second set of blocks in the set of memory dies based at least in part on a performance metric.

3. The apparatus of claim 2, wherein the controller is further configured to cause the apparatus to:
determine that the performance metric satisfies a threshold, wherein the data file is written to the second set of blocks based at least in part on the performance metric satisfying the threshold.

4. The apparatus of claim 1, wherein the controller is further configured to cause the apparatus to:
determine, based at least in part on performance mapping information, that the performance metric corresponds to the quantity of read operations, wherein the performance metric is determined based at least in part on the performance metric corresponding to the quantity of read operations.

5. The apparatus of claim 4, wherein the performance mapping information is included in a performance mapping table, and wherein the controller is further configured to cause the apparatus to:
select the performance mapping table from a plurality of performance mapping tables based at least in part on a size of the range of logical block addresses.

6. The apparatus of claim 1, wherein the controller is further configured to cause the apparatus to:
determine, based at least in part on the address mapping information, that a second logical block address associated with the data file and sequential to a first logical block address associated with the portion of the data file is mapped to a second memory die, wherein the quantity of read operations is determined based at least in part on the second logical block address being mapped to the second memory die.

7. The apparatus of claim 1, wherein the controller is further configured to cause the apparatus to:
determine, based at least in part on the address mapping information, that a second logical block address associated with the data file and sequential to a first logical block address associated with the portion of the data file is mapped to a different page line than the first logical block address, wherein the quantity of read operations is determined based at least in part on the second logical block address being mapped to the different page line.

8. The apparatus of claim 1, wherein the controller is further configured to cause the apparatus to:
determine, based at least in part on the address mapping information, that a first logical block address associated with a first subset of the portion of the data file is mapped to a first physical address; and
determine, based at least in part on the address mapping information, that a second logical block address associated with the data file and sequential to the first logical block address is mapped to a second physical address that is non-sequentially indexed relative to the first physical address, wherein the quantity of read operations is determined based at least in part on the second physical address being non-sequentially indexed relative to the first physical address.

9. The apparatus of claim 1, wherein the controller is further configured to cause the apparatus to:
determine a threshold quantity of access operations associated with the data file, wherein the performance metric is determined based at least in part on the threshold quantity of access operations.

10. The apparatus of claim 9, wherein the controller is further configured to cause the apparatus to:
divide the quantity of read operations by the threshold quantity of access operations, wherein the performance metric is determined based at least in part on dividing the quantity of read operations by the threshold quantity of access operations.

11. The apparatus of claim 10, wherein the range of logical block addresses comprises a quantity of logical block addresses, and wherein the threshold quantity of access operations is based at least in part on the quantity of logical block addresses in the range of logical block addresses divided by a quantity of virtual pages per page line of the set of memory dies.

12. The apparatus of claim 1, wherein the controller is further configured to cause the apparatus to:
read an address mapping table from memory after writing the data file to the set of memory dies, wherein the address mapping information is included in the address mapping table.

13. The apparatus of claim 1, wherein the performance metric indicates an increase in latency for reading the data file relative to a threshold latency for reading the data file.

14. The apparatus of claim 1, wherein the performance metric indicates a latency for reading the data file written to the first set of blocks.

15. A method, comprising:
writing a data file associated with a range of logical block addresses to a first set of blocks in a set of memory dies;
determining, for a memory die of the set of memory dies that stores a portion of the data file, a quantity of read operations for reading the portion of the data file based at least in part on address mapping information that maps logical block addresses associated with the data file to physical addresses; and
determining a performance metric associated with the data file and the first set of blocks based at least in part on the quantity of read operations.

16. The method of claim 15, further comprising:
writing the data file to a second set of blocks in the set of memory dies based at least in part on a performance metric.

17. The method of claim 16, further comprising:
determining that the performance metric satisfies a threshold, wherein the data file is written to the second set of blocks based at least in part on the performance metric satisfying the threshold.

18. The method of claim 15, further comprising:
determining, based at least in part on performance mapping information, that the performance metric corresponds to the quantity of read operations, wherein the performance metric is determined based at least in part on the performance metric corresponding to the quantity of read operations.

19. The method of claim 18, wherein the performance mapping information is included in a performance mapping table, the method further comprising:
selecting the performance mapping table from a plurality of performance mapping tables based at least in part on a size of the range of logical block addresses.

20. The method of claim 15, further comprising:
determining, based at least in part on the address mapping information, that a second logical block address associated with the data file and sequential to a first logical block address associated with the portion of the data file is mapped to a second memory die, wherein the quantity of read operations is determined based at least in part on the second logical block address being mapped to the second memory die.

21. The method of claim 15, further comprising:
determining, based at least in part on the address mapping information, that a second logical block address associated with the data file and sequential to a first logical block address associated with the portion of the data file is mapped to a different page line than the first logical block address, wherein the quantity of read operations is determined based at least in part on the second logical block address being mapped to the different page line.

22. The method of claim 15, further comprising:
determining, based at least in part on the address mapping information, that a first logical block address associated with a first subset of the portion of the data file is mapped to a first physical address; and
determining, based at least in part on the address mapping information, that a second logical block address associated with the data file and sequential to the first logical block address is mapped to a second physical address that is non-sequentially indexed relative to the first physical address, wherein the quantity of read operations is determined based at least in part on the second physical address being non-sequentially indexed relative to the first physical address.

23. The method of claim 15, further comprising:
determining a threshold quantity of access operations associated with the data file, wherein the performance metric is determined based at least in part on the threshold quantity of access operations.

24. The method of claim 23, further comprising:
dividing the quantity of read operations by the threshold quantity of access operations, wherein the performance metric is determined based at least in part on dividing the quantity of read operations by the threshold quantity of access operations.

25. A non-transitory, computer-readable medium storing code comprising instructions which, when executed by a processor of a memory system, cause the memory system to:
write a data file associated with a range of logical block addresses to a first set of blocks in a set of memory dies;
determine, for a memory die of the set of memory dies that stores a portion of the data file, a quantity of read operations for reading the portion of the data file based at least in part on address mapping information that maps logical block addresses associated with the data file to physical addresses; and
determine a performance metric associated with the data file and the first set of blocks based at least in part on the quantity of read operations.
